(19) United States
(12) Patent Application Publication
(10) Pub. No.: US 2002/0165762 A1
(43) Pub. Date: Nov. 7, 2002

(54) Method for integrated analysis of safety, efficacy and business aspects of drugs undergoing development

(75) Inventors: Arnold J. Goldman, Jerusalem (IL); Lewis Rosen, Jerusalem (IL); Mark Taragin, Jerusalem (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Clinical Discovery Israel Ltd.

(21) Appl. No.: 10/136,396

(22) Filed: May 2, 2002

Related U.S. Application Data
(60) Provisional application No. 60/287,742, filed on May 2, 2001.

(51) Int. Cl. G06F 17/60

(52) U.S. Cl. 705/10

(57) ABSTRACT

A method of increasing a probability of a positive outcome of application over a population, of a pharmaceutically active product, the method comprising: obtaining data including patient data of said population, and dosage data, efficacy result data and safety result data of said application, and revenue and financial results data and analytically processing said data to find subgroupings within said population that react similarly to said application, thereby to arrive at a dosage recommendation based on safety, efficacy and revenue and financial results of said pharmaceutically active product for at least one of said subgroupings, said safe dosage level recommendation being arrived at to maximize said probability of a positive outcome.

### INDUSTRY BACKGROUND

The process of developing drugs is long and expensive It is estimated that a new drug application will cost $500 M to $800 M or more in today's terms, spent over the ten to twelve years prior to regulatory approval. Large pharmaceutical companies typically have an ongoing drug development program in which several hundreds or thousands of new chemical entities (NCEs) arc investigated each year. The process includes several sequential stages, starting with chemical assays, lab tests with specific tissue samples, animal tests, and continuing through to clinical trials involving humans

The clinical trial stage is itself divided into three phases, each involving steadily larger samples of participants. Phase I focuses on demonstrating safety. Phase II on demonstrating efficacy against the illness being treated. Following Phase II, the drug is subject to much wider efficacy and safety testing in Phase III, usually involving several thousand patients with the pathology being treated. At the end of Phase III, the pharmaceutical company or biotech company (henceforth, “pharmaceutical company” will refer to both pharmaceutical and biotech companies) typically submits an application to the US Federal Drug Administration sir other regulatory authorities (henceforth, “regulatory authorities”) seeking approval to market the drug.

Once a drug is approved and general use begins, safety monitoring of patients using the drug generally occurs. This stage is referred to as Phase IV and sometimes its results lead to a drug being withdrawn from the market or its user populations significantly narrowed by the regulatory authorities. This occurs when Phase IV results show an unacceptably high incidence of adverse drug impacts, and sometime death, associated with user experience with the drug.

At each stage of the drug development process, some drugs are dropped based on unfavorable test results, with the percentage of tested drugs that are dropped being particularly high at earlier stages of the process. As a result, relatively small numbers of drugs reach the human trials stage, and an even smaller number are submitted to the regulatory authorities for approval.

Of all the drugs entering Phase III trials, about 85% are eventually submitted for approval, with the remaining 15% being voluntarily withdrawn before the submission stage. About 70% of the drugs submitted (or about 60% of all drugs going into Phase III) receive the approval of the FDA, the US regulatory authority

### THE EXISTING METHOD

Pharmaceutical companies currently undertake and present to regulatory authorities conventional statistical analysis of patient data obtained during all Phase I, II, and III clinical trials for the drug. These statistical analyses include hypothesis testing, analysis of variance, and other techniques. The data includes patient demographic measures, various patient health measures and lab test results taken during the clinical trials, and patient dosage levels of the drug being tested.

The general pharmaceutical company approach to drug dosing is an important element of the prior art. When submitting a new drug for approval, pharmaceutical companies normally propose a single dosage for all patients. In a minority of instances, they propose a few alternative dosages for particular segments of the target user population. The preference for uniform dosages is based on trying to reduce manufacturing costs and to simplify the physician's task in determining appropriate dosages for specific patients.

### DISCUSSION OF BENEFITS OF IMPROVED METHOD OF EVALUATING DRUGS

Although the percentage of drugs that fail at Phase III is lower than at earlier phases of the drug development process, the fact that about 40% of drugs that begin Phase III ultimately do not reach market, and the lengthy average time until regulatory approval is received for the approximately 60% that are approved both represent serious inefficiencies of current methods. Raising the success percentage and reducing the average time until approval would both save valuable resources and increase the revenues from approved drugs during their periods of patent and other exclusivity protection.

Furthermore, the consequences of a specific drug unexpectedly failing at Phase III can be critical to the company's market valuation because the anticipated revenues from the drug may already be included in investor valuations of the pharmaceutical company.

The unexpected rejection of one or more drugs after Phase III trials can lead to sharp deterioration in the company's current and anticipated future profitability, resulting in a major decline in company valuation.

However, pharmaceutical companies are not concerned only, with increasing the probability that a drug will be approved by the regulatory authorities. Rather, they are also very interested in maximizing the revenues and other financial measures associated with a new drug. In choosing which set of dosages to propose to regulatory authorities, the pharmaceutical company needs a method for weighing, in a consistent manner, both the probability of regulatory approval and the predictive revenues and other financial measures associated with the proposed set of dosages.

Therefore, it would be highly advantageous for pharmaceutical companies to be able to use drug evaluation and dosage recommendation methods that would increase the success rate of drugs enter Phase III clinical trials, reduce average time until approval, and have a method of ranking alternative sets of dosages in terns of their anticipated probability of regulatory approval and anticipated revenues and other financial measures.

### SUMMARY OF THE INVENTION

According to a first aspect of the present invention there is provided a method of increasing a probability of a positive outcome of application over a maximized population, of a pharmaceutically active product, the method comprising, obtaining data including patient data of the population, and dosage data, efficacy data and safety result data of the application, analytically processing the data to find subgroupings within the population that react similarly to the application, to relate dosage data to subgroupings within the population, thereby to arrive at a safe and efficacious dosage recommendation of the pharmaceutically active product for at least one of the subgroupings, the safe dosage level recommendation being arrived at to maximize the probability of a positive outcome, and analytically processing at least one subgrouping using associated financial data to find an economic value for the application to the subgrouping.

According to another aspect of the present invention there is provided a method of increasing a probability of a positive outcome of application, over a population, of a pharmaceutically active product, the method comprising: obtaining data including patient data of the population, and dosage data, safety result data, and efficacy result data of the application, and analytically processing the data to relate the dosage data, the patient data, the safety result data and the efficacy data to the patient data, to form therefrom subgroupings within the population, each of the subgroupings being related by similarity in at least one of the types of data, thereby to arrive at an actuarially robust safe and efficacious dosage recommendation of tile pharmaceutically active product for at least one of the subgroupings, the safe dosage level recommendation being arrived at to maximize the probability of a positive outcome, the method further comprising calculating for at least one of the subgroups a first index of a combination of respective safety and efficacy levels, the first index being usable to find subgroups optimized for the combination of safety and efficacy According to yet another aspect of the present invention there is provided a method of distinguishing between different ways of dividing a population into dosage application subgroups for treatment with an active pharmaceutical product, the method comprising: providing a plurality of sets of subgroupings of the population, for the population obtaining economic data, for each subgrouping generating an economic value of providing the treatment to the subgroup, indexing each set according to economic values of respective subsets, and selecting one of the sets based on at least the indexing.

According to still another aspect of the present invention there is provided an apparatus for increasing a probability of a positive outcome of application over a population, of a pharmaceutically active product, the apparatus comprising an input for receiving data including patient data of the population, and dosage data, safety result data and efficacy result data of the application, an analytical processor for analytically processing the data to form subgroupings within the population showing substantially similar results, thereby to arrive at a safe and efficacious dosage recommendation of the pharmaceutically active product for at least one of the subgroupings, the safe dosage level recommendation being arrived at to maximize the probability of a positive outcome, the analytical processor being able to repeat the analytical processing to provide different sets of subgroupings of the population, a first indexer for indexing the subgroupings according to a combination of safety and efficacy levels, and an index summing for carrying out a summation of the index over respective sets, thereby to provide a means of comparing different sets to find an optimal set.

According to an additional aspect of the present invention there is provided a combination population subgroup identifier and pharmaceutical application dosage calculator comprising: a first input for receiving patient specific categorization data of patients in a population, the data being selected by suitability for define population subgroups with respect to the application, a second input for receiving applied dosage data patientwise, a third input for receiving efficacy result data of the application patientwise, a fourth input for receiving safety result data of the application patientwise, a processor for processing data of the inputs to define subgroups of the population showing similar result data, a dosage determiner for applying at least one of a safety threshold rule and an efficacy threshold rule to at least one of the subgroups to determine a safe or efficacious dosage level for the at least one subgroup, and and indexer for applying to the at least one subgrouping an index expressing a combination of a safety level and an efficacy level of the subgrouping.

According to further features in preferred embodiments of the invention described below, the stage of analytically processing the data to find subgroupings comprises calculating a first index combining safety and efficacy levels for the dosage recommendation.

According to still further features in the described preferred embodiments, the method further includes repeating the stage of analytically processing the data to find a further set of at least one subgroupings, and repeating the stage of analytically processing the at least one subgrouping, thereby to obtain a plurality of sets of at least one subgrouping each associated with a respective economic value, and each having a respective combined index of safety and efficacy.

According to still further features in the described preferred embodiments, the method further includes, for each set of at least one subgrouping, calculating a second index, the second index expressing a combination of the respective economic value and the respective first index.

According to still further features in the described preferred embodiments, the method further includes selecting one of the sets of at least one subgrouping based on the respective second index.

According to still further features in the described preferred embodiments the second index is calculated to provide a maximum for a best combination of the first index and the economic value, thereby to indicate a dosing regime subgroup set optimized for each of efficacy, safety and economic return.

According to still further features in the described preferred embodiments the analytically processing comprises finding a population subgrouping showing a substantially similar efficacy result following application of a predetermined dosage.

According to still further features in the described preferred embodiments the analytically processing comprises finding a population subgrouping showing a substantially similar safety result following application of a predetermined dosage.

According to still further features in the described preferred embodiments the analytically processing comprises finding a population subgrouping showing substantially similar safety and efficacy results following application of a predetermined dosage.

According to still further features in the described preferred embodiments the safety result is at least one of a group comprising a liver function result a QT result, and a renal performance result.

According to still further features in the described preferred embodiments the first index is calculated to provide an optimal combination of safety and efficacy.

According to still further features in the described preferred embodiments the obtaining data comprises obtaining data of standard pharmaceutical product tests, or obtaining historical use data of the product, or obtaining historical data of other pharmaceutically active products similar to the product.

According to still further features in the described preferred embodiments the obtaining data is preceded by a stage of selecting patient data categories for providing a basis for defining respective population subgroupings

According to still further features in the described preferred embodiments, the method further includes providing dosage recommendations subgroupwise over the population.

According to still further features in the described preferred embodiments the obtaining data comprises obtaining blood serum level data of patients within the population

According to still further features in the described preferred embodiments the method includes using a probability threshold to select the safe dosage recommendation

According to still further features in the described preferred embodiments the probability threshold is an actuarially verifiable probability threshold.

According to still further features in the described preferred embodiments the obtaining data is preceded by a stage of selecting data categories to be obtained, and wherein the selecting comprises use of at least one technique selected from the group consisting of; a knowledge tree, the knowledge tree including interconnection cells describing qualitative and quantitative relationships between inputs and outputs, and a decision making optimization technique.

According to still further features in the described preferred embodiments the analytically processing comprises using discrete vectorization modeling to analyze the population into the population subgroupings.

According to still further features in the described preferred embodiments the discrete vectorization modeling comprises representing the subgroupings as respective vectors within a discrete vector analytical model. According to still further features in the described preferred embodiments, the method further includes au updating stage of obtaining new data to an accumulated data mass, and using the updated accumulated data mass in repeat analytical processing, thereby to update the subgroupings.

According to still further features in the described preferred embodiments, the method further includes an updating stage of obtaining new data to an accumulated data mass, and using the updated accumulated data mass in repeat analytical processing, thereby to update the subgroupwise dosage recommendations.

According to still further features in the described preferred embodiments further comprising an updating stage of obtaining new data to an accumulated data mass, and using the updated accumulated data mass in repeat analytical processing, thereby to update the subgroupings and the associated subgroupwise dosage recommendations.

The present invention addresses the shortcomings of the presently know configurations by providing a method and system for improving safety and increasing efficacy, to reduce the risk that a drug in Phase III clinical trials will be rejected by regulatory authorities, and a method of ranking alternative sets of dosages in terms of their anticipated probability of regulatory approval and anticipated revenues and other financial measures

The invention may be used in a “feed-forward” manner to choosing appropriate dosage upon input of the specific patient's demographic/medical history/current health status input variables.

The present invention addresses the shortcomings of the presently known configurations by providing a method for processing clinical trials and other data. The processing of the data is undertaken by way of a separate analysis of safety output variables, a separate analysis of efficacy output variables, and a method of combining the separate analyses of safety and efficacy output variables, referred to as “medical advantage” and involving an index referred to as “the first index”. In addition, the method includes analysis of business and financial impacts of the drug under consideration, which analysis is taken into account by the pharmaceutical company in both making decisions regarding recommended drug dosages and whether or not to proceed with development of the drug under consideration. It is envisioned that the safety, efficacy, medical advantage, business analysis modules will be used in an integrated manner for optimizing the probability that a drug compound will obtain regulatory approval and realize specific pharmaceutical company financial objectives. In particular, the method includes the weighting of the medical advantage index for the drug and the projections of revenues and other financial measures to as to arrive at a combined medical advantage—business analysis index (referred to as “the second index”). The higher the value of the index, the more preferred the set of dosages associated with the index value. The pharmaceutical company can therefore choose a preferred set of dosages in light of these two factors—medical advantage (reflecting safety and efficacy) and revenues and other financial measures.

The analysis of safety output variables involves mapping the relationships between relevant input variables and one or more specific safety output variables associated with one or more safety problems that may arise from use of the drug. The relevant input variables would include drug dosage and frequency. For particular population segments it would be possible to find dosages of the drug associated with unfavorable safety effects and to find dosages of the drug not associated with unfavorable safety effects.

The analysis of efficacy variables involves mapping the relationships between relevant input variables and one or more specific efficacy output variables associated with the pathology being studied in the clinical trials. The relevant input variables would include drug dosage and frequency. For particular population segments, it would be possible to find dosages of the drug associated with unfavorable efficacy effects and to find dosages of the drug not associated with unfavorable efficacy effects.

Because approval by the FDA and other regulatory authorities is based on both the drug's efficacy and its safety, and because the choice of drug dosages can affect both the drug's safety profile and efficacy profile, there is a need for a method that combines the separate analyses of safety and efficacy output variables. Such a method involves a transformation process that takes the separate safety results for particular drug dosages and the separate efficacy results for the same drug dosages and combines them in order obtain a value (which might be called the “medical advantage index”, also referred to as the “first index”). The transformation process takes into account an assessment of how specific combinations of safety and efficacy results would be appraised by regulatory authorities. The use of the medical advantage index would enable pharmaceutical companies to optimize the probability of success in obtaining regulatory approval by choosing the set of drug dosages that achieves the highest value of the medical advantage index.

It was mentioned that an aspect of the prior art is a preference to recommend a uniform dosage for all users of a drug, rather than recommending different dosages for different population subgroups. If the pharmaceutical company continues with a preference for a uniform dosage, the present method will enable the pharmaceutical company to identify the optimal uniform dosage. In general, moving away from uniform dosages would enable a more customized set of dosages, resulting in better safety and/or better efficacy results for the drug. The present method would allow a pharmaceutical company to choose an optimal set of dosages customized for specific population subgroups.

However, the pharmaceutical company may not want to choose which set of dosages (C) propose to regulatory authorities only on the basis of maximizing the probability of regulatory approval. Rather, it is also interested in obtain favorable revenues and other financial measures associated with the marketing of the drug. Associated with the choice of any particular dosage(s) would be a list of particular population subgroups who would be recommended to use the drug because it is believed to be safe and efficacious for such groups, and a list of particular population subgroups who would be recommended not to use the drug because the it is believed that the drug may not be safe and efficacious for such groups. The population sizes of the subgroups recommended to use the drug could be used to estimate the total target user population for the drug, which would be a critical variable in a business analysis model for the drug. This model takes account of the market for the drug, the existing or competing drugs, assumed marketing and pricing policies, and other factors relevant to projecting the revenues for the drug and other financial impacts on the pharmaceutical company.

With the proposed method, a pharmaceutical company may choose the recommended dosage(s) for the drug based on two targets: the probability of receiving regulatory approval, and projected revenues and or other financial results. For example, rather than choosing the dosages that maximize the probability of regulatory approval, while resulting in relatively lower level of revenues, a pharmaceutical company might prefer alternative dosages that are projected to result in higher revenues though not the maximum probability of receiving regulatory approval.

It is envisioned that the safety, efficacy, medical advantage, business analysis modules will be used in an integrated manner for choosing an optimal set of dosages, taking account of both the probability that a drug compound will obtain regulatory approval and the drug's predicted financial results.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow chart of prior art regarding analysis of data for a drug compound;

FIG 2 is a flowchart of a method for analysis of data for a drug compound to enhance safety/efficacy prospects;

FIG. 3 is an illustration of a Knowledge Tree used for logical mapping of safety inputs and outputs;

FIG. 4 is an illustration of a Knowledge Tree used for logical mapping of efficacy inputs and outputs;

FIG. 5 is an illustration of a Knowledge Tree showing how the outputs of the safety and efficacy Knowledge Trees are two of the inputs to the calculation of a “Medical Advantage” output index (the “first index”),

FIG. 6 is a graphic representation of a optimization process based on optimizing medical advantage,

FIG. 7 is a graphical representation of optimization process applied to the choice of optimal dosage;

FIG. 8 is a simplified block diagram showing an apparatus for providing recommended drug dosage levels for a population or subgroups thereof according to a preferred embodiment of the present invention;

FIG. 9 is a simplified block diagram of a Business Analysis Knowledge Tree;

FIG. 10 is a graphical representation of a SEMBA (Safety Efficacy Medical advantage Business Analysis) Knowledge free for optimizing drug dosages to achieve a preferred index (“the second index”) combining Medical Advantage and financial outcomes, and

FIG. 11 is a simplified flow chart showing the procedure for selecting a dosing regime over a population, according to one of the embodiments of the present invention.

### DESCRIPTION OF THE PREFERRED EMBODIMENTS

The present embodiments relate to a method related to development and early use of new drugs and, more particularly, to a method which can be applied to a drug being tested in Phase III clinical trials to increase the percentage of drugs that succeed in receiving regulatory approval following Phase III and reduce the average amount of time until regulatory approval is received.

In addition to benefiting the pharmaceutical company, reducing the incidence of adverse effects may benefit patients using the drugs and may reduce treatment costs associated with patients hospitalized due to adverse effects of drugs, which is a significant cause of hospitalization and non-hospital morbidity and mortality. Properly used pharmaceutical products have been found to be between the 4^{th} and the 8^{th} largest cause of death in the US.

The present embodiments comprise a method and/or apparatus for increasing the probability that a drug in Phase III clinical trials may receive regulatory approval. Additionally, the present embodiments may enlarge the amount of data to be studied while the drug is in clinical trials, and while it is in the market, to include periodic patient blood serum and other standard test results and other non-standard test results, and to include historical data relevant to the drug compound being tested or used. Additionally, the use of the present embodiments may enable finding evidence of favorable efficacy effects and adverse safety effects through more extensive and more effective analysis of population segments than is currently performed. These abovementioned results are achieved through the use, in the present embodiments, of expert knowledge combined with qualitative modeling techniques, use of discrete segment quantitative techniques, and the analysis of significant patterns linking input variables and output variables, as will be described in greater detail below. Additionally, the use of the present embodiments may enable discovering optimal dosages for specific population segments, eliminating some adverse safety/efficacy effects through changes in dosages, and excluding from the target user population those population segments where unfavorable safety/efficacy outcomes cannot be eliminated through drug dosage optimization. Additionally, the use of the present embodiments may provide a method of ranking alternative sets of dosages in terms of their anticipated probability of regulatory approval and anticipated revenues and other financial measures, enabling a pharmaceutical company to choose the preferred set of dosages on the basis of both objectives.

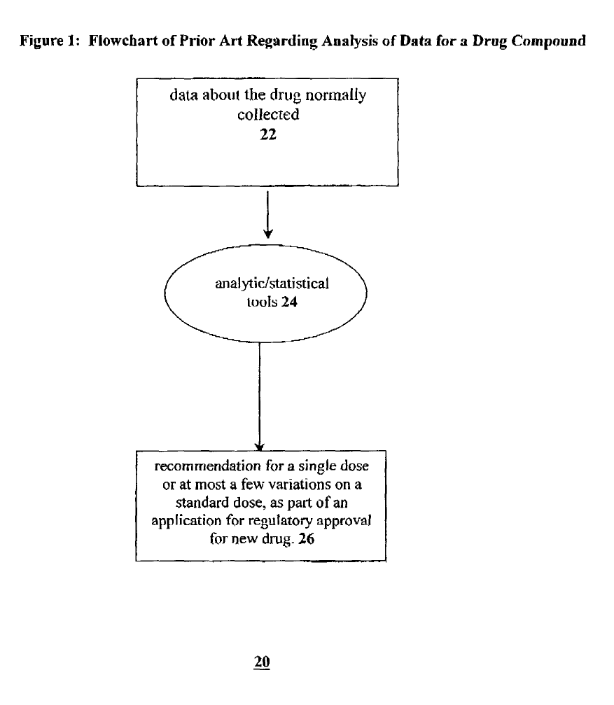

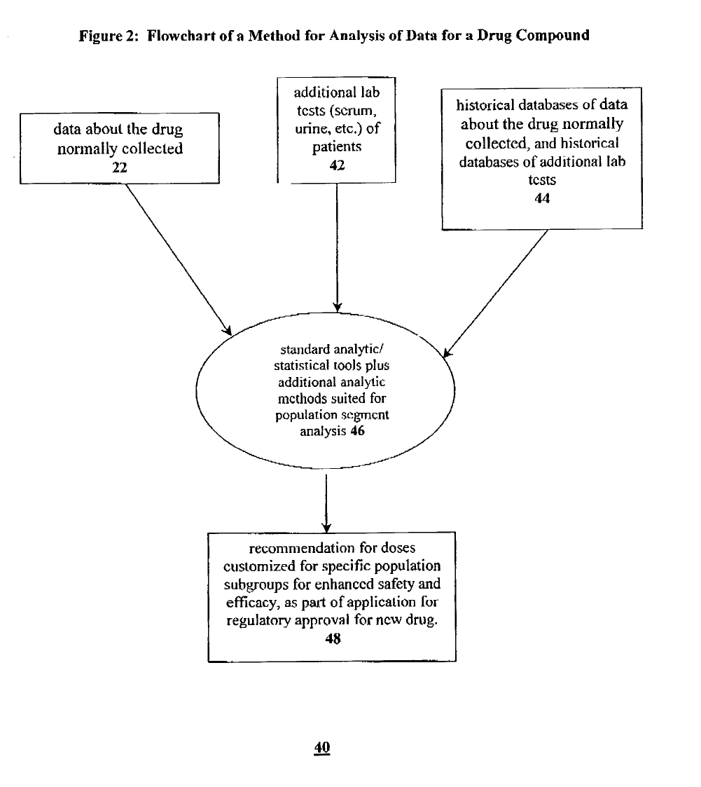

For purposes of better understanding the present invention, as illustrated in FIGS. 2-10 of the drawings, reference is first made to the construction and operation of a conventional (i.e., prior art) data analysis of drug compounds in pre- and post-regulatory approval as illustrated in FIG. 1

FIG. 1 is a flow chart of prior art illustrating the method 20 of analysis of data for a drug compound Data about the drug normally collected 22, for example for a drug prior to regulatory approval, include pre-clinical trials laboratory and animal data for the drug compound in addition to Phases III patient data. The data are fed into analytical and statistical tools 24 where they are then analyzed and, on the basis of this analysis, a single dosage or at most a few variations on a standard dosage are then recommended, as part of an application for regulatory approval for a new drug 26. Today, a certain percentage of applications are rejected by regulatory authorities and the drug cannot be marketed. Such a rejection is included in the concept hereinafter referred to as a negative outcome,; whereas a positive outcome includes approval by regulatory authority, and whereas a positive outcome with higher revenues and other financial results is preferred to a positive outcome with lower revenues and other financial results.

The present invention describes a method of increasing the probability of a positive outcome of application over a maximized population, of a pharmaceutically active product. The method includes a series of steps for providing an increase of probability of a positive outcome of application over a maximized population, of a pharmaceutically active product The first step is obtaining data including patient data of the population, sold dosage data, efficacy data and safety result data of the application. The stage (if obtaining data includes at least any one of the following; obtaining data of standard pharmaceutical product tests, obtaining data of non-standard pharmaceutical product tests; obtaining historical use data of the product, obtaining historical data of other pharmaceutically active products similar to the product or obtaining blood serum level data of patients within the population and is preceded by a stage of selecting patient data categories for providing a basis for defining respective population subgroupings.

The next step is analytically processing the data to find subgroupings within the population that react similarly to the application, to relate dosage data to subgroupings within the population The method will analyze safety effects for population subgroupings, including the effects of different drug dosages, and will separately analyze efficacy effects for population subgroupings, including the effects of different drug dosages. The method may then arrive at a safe and efficacious dosage recommendation of the pharmaceutically active product for at least one of the subgroupings. The stage of analytically processing the data to find subgroupings comprises calculating a first index combining safety and efficacy levels for the dosage recommendation. The first indexer works by taking safety results, efficacy results, and information about how regulatory authorities evaluate various safety and efficacy combinations and assigning a single index number to a given combination of safety and efficacy results The higher the index value, the greater the probability that the safety-efficacy combination would be approved by the regulatory authorities.

The next step is analytically processing the at least one subgrouping using associated financial data to find an economic value for the application to the subgrouping. The economic value would first depend on whether a subgroup will be taking the drug, and if so, would be based on an estimate of the population of the subgroup that would take the drug. Other economic factors such as market size, competition, marketing plans, pricing plans, and costs would be taken into account in order to generate an economic value, which may be projected revenues or other widely used financial measures. Therefore, the method could be used to maximize the estimated economic value by choosing the set of dosages associated with the highest economic value.

The method further includes the steps of repeating the stage of analytically processing the data to fund a further set of at least one subgroupings, and repeating the stage of analytically processing the at least one subgrouping, thereby to obtain a plurality of sets of at least one subgrouping each associated with a respective economic value, and each having a respective combined index of safety and efficacy.

The method further includes for each set of at least one subgrouping, calculating a second index, the second index expressing a combination of the respective economic value and the respective first index. The first index is a positively correlated with die probability that the drug will be approved by regulatory authorities, and the economic value is a relevant measure of the revenues or other financial aspects of the drug. The second index takes account of the tradeoff between different levels of the probability of regulatory approval and the drug's economic value to the pharmaceutical company, and the higher the value of the overall or second index, the greater the preference from the point of view of the pharmaceutical company. Each set of drug dosages for specific population subgroupings is therefore associated with a specific value for the overall or second index.

The second index is calculated to provide a maximum for a best combination of the first index and the economic value, thereby to indicate a dosing regime subgroup set optimized for each of efficacy and safety and economic return. Then one of the sets of at least one subgrouping based on the respective second index is selected.

The step of analytical processing includes the step of finding a population subgrouping showing a substantially similar efficacy result following application of a predetermined dosage, or finding a population subgrouping showing a substantially similar safety result following application of a predetermined dosage or finding a population subgrouping showing substantially similar safety and efficacy results following application of a predetermined dosage. The safety results can be at least any one of a liver function result, a QT result, and a renal performance result.

The method further includes providing dosage recommendations subgroupwise over the population.

The method further includes using a probability threshold to select the safe dosage recommendation, wherein the probability threshold is an actuarially verifiable probability threshold.

The step of obtaining data is preceded by a stage of selecting data categories to be obtained, and wherein the selecting comprises use of at least one technique selected from the group consisting of a knowledge tree, the knowledge tree including interconnection cells describing qualitative and quantitative relationships between inputs and outputs, and a decision making optimization technique.

The discrete vectorization modeling includes representing the subgroupings as respective vectors within a discrete vector analytical model.

The method further includes an updating stage of obtaining new data to an accumulated data mass, and using the updated accumulated data mass in repeat analytical processing, thereby to update the subgroupings.

The method further includes an updating stage of obtaining new data to an accumulated data mass, and using the updated accumulated data mass in repeat analytical processing, thereby to update the subgroupwise dosage recommendations.

The method further includes an updating stage of obtaining new data to an accumulated data mass, and using the updated accumulated data mass in repeat analytical processing, thereby to update the subgroupings and the associated subgroupwise dosage recommendations.

Each of the above steps will be more fully discussed hereinafter in the context of examples illustrated in the subsequent drawings.

According to the present embodiments, the occurrence of a positive outcome for a drug in the process of development is reduced. FIG. 2 illustrates method 40 of risk management related to new drugs. Data about the drug normally collected 22, together with additional lab tests (serum, urine, etc) of patients 42, including non-standard test results, and historical databases of data about the drug normally collected, and historical databases of additional lab tests 44 are collected. Then standard analytic/statistical tools plus additional analytic methods suited for population segment analysis 46 are used for analyzing the collected data. Finally, dosages are recommended and customized for specific population subgroups for enhanced safety and efficacy, as part of an application for regulatory approval for new drug 48.

The beneficiaries of the risk reduction provided by the method are numerous. Clearly, the pharmaceutical company is a main beneficiary. Other beneficiaries would likely include the patients themselves for whom the occurrence of adverse effects associated with non-optimal drug dosages, HMO's and other health service providers and insurance companies including governmental health insurers would avoid costs incurred in treating patients experiencing avoidable adverse effects of drug use. Beneficiaries may also include drug formularies of HMOs and hospitals, which select specific drugs to use for particular patients. Additionally, regulatory authorities may benefit by adopting or encouraging the present method by being able to approve new drugs having a higher level of safety and/or efficacy.

In addition to usual data currently analyzed by pharmaceutical companies, according to the method described in this invention, patient serum lab data (to be collected on a more frequent basis than now done during the clinical trials) and relevant historical data for similar drugs and for patients similar to those being tested in the clinical trials, in addition to relevant data for patients who are not similar, including relevant historical serum lab data, may be included.

In addition to conventional analytical techniques and hypothesis testing, e.g., analysis of variance, linear regression, logistic regression, CART, other statistical techniques now used by pharmaceutical companies, the insurer may apply a set of additional analytic techniques, which include the following:

a) Building Knowledge Trees (KT) for mapping the relationships between input and output variables. A Knowledge Tree is a mapping of causal relationships between inputs and outputs. It breaks down a complex process with many input variables and at least one output variable into separate more manageable interrelated processes, each with a smaller, easier to handle, number of variables.

b) Using a quantitative modeler such as Process Output Empirical Modeler (POEM) in developing quantitative models of the KT relationships between the inputs and the outputs to undertake population subgroup analysis; and

c) Optimization of dosages using optimization techniques such as APC techniques.

These are now discussed in more detail.

(a) Building Knowledge Trees between input and output variables

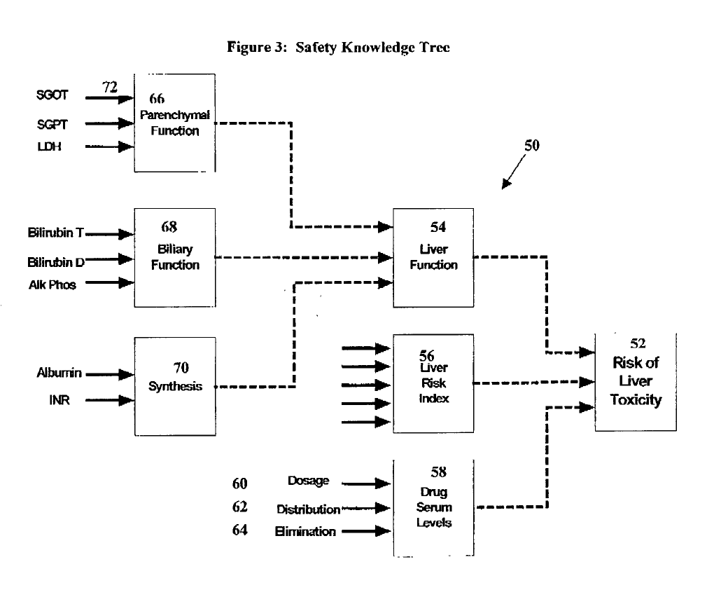

Reference is now made to FIG. 3, which is a simplified example of the structure of a Knowledge Tree (KT) 50 suitable for the safety analysis of the drug used to predict the risk of liver toxicity 52. The main factors are liver function 54, liver risk index 56, and drug serum levels 58. Each of these factors (called Knowledge Cells) are outputs from other factors, for example drug serum levels are dictated by the dosage 60, distribution 62, and elimination 64 characteristics of the drug 64. FIG. 3 further illustrates an example of an additional lower level in Knowledge Tree (KT) 50. The Knowledge tree cell liver function 54 has its contributing factors, or inputs parenchymal function 66, biliary function 68 and synthesis 70. The abovementioned lower level are the contributing factors to parenchymal function 66, biliary function and synthesis 68 shown in FIG. 3, for example SGOT 72 which is one of the three illustrated contributing factors to parenchymal function 66.

The KT illustrated in FIG. 3 could be used to show how a change in the dosage of drug A 76, given the value of all other input variables, may impact the safety output variable 787 which is measure of the drug's safety. It might be found that with a high dosage of drug A that output variable 78 indicates an unfavorable safety outcome, while with a medium dosage of drug A there would not be an unfavorable safety outcome.

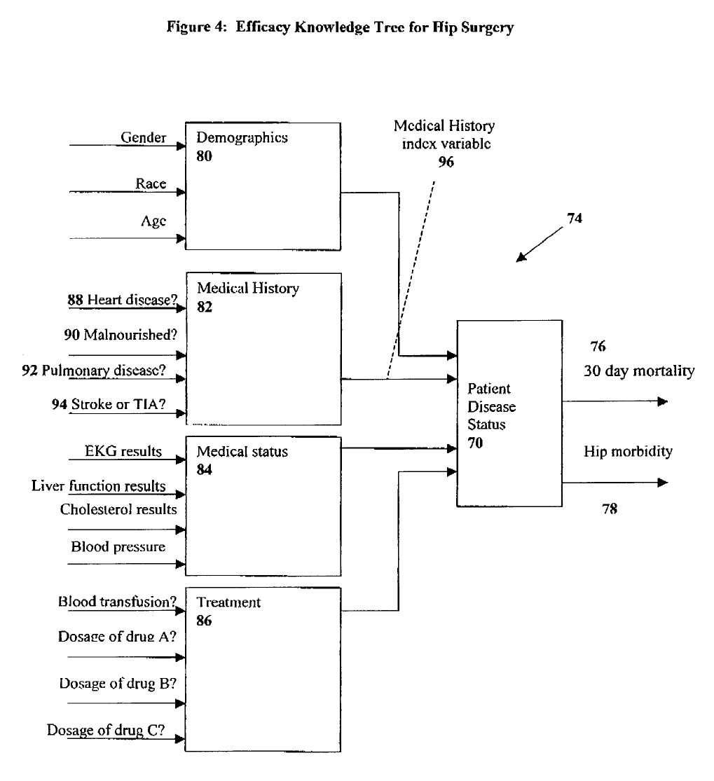

Reference is now made to FIG. 4, which is a simplified diagram of a knowledge tree representing factors relevant to the outcome of hip surgery.

The Knowledge Tree depicted in FIG. 4 is a knowledge tree 74 created to measure efficacy, specifically in relation to hip surgery, and has more than one output or possible outcome such as 30 day mortality 76 and hip morbidity 78. The main factors driving these outputs are the patient's Demographics 80, Medical Status 84, and Treatment 86. Each of these factors can in turn be the result of other factors. For example, the main drivers of Medical History 82 (for hip surgery) are whether the patient has a history of heart disease, being malnourished, pulmonary disease, or has suffered a stroke or TIA. The output of the knowledge tree cell of Medical History 82 for example is Medical History index variable 96.

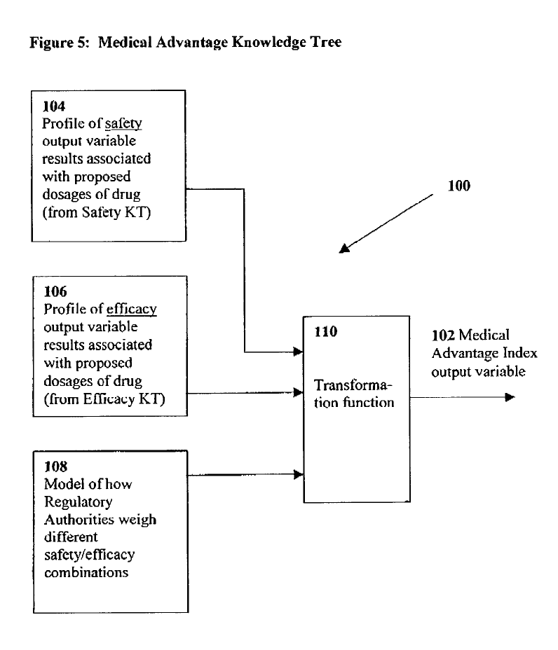

Knowledge trees may be defined for safety of a particular procedure including drug application, that is to say, does it harm the patient?; and a different knowledge tree may be defined for efficacy, that is to say, does it achieve the desired beneficial result?. The Safety Knowledge Tree and the Efficacy Knowledge Tree thus separately measure the influence of specific drug dosages on safety and efficacy There is a need to combine these effects and rank each combination, because the regulatory authorities are interested in both safety and efficacy in deciding whether to approve a new drug for introduction to the market. FIG. 5 shows a method of ranking each safety/efficacy combination in a medical advantage knowledge tree 100.

A “Medical Advantage Index”(also referred to as the “first index”) 102 is an index that ranks each possible set of drug dosages Such ranking reflects an estimate of the likelihood that regulatory authorities may approve the drug, with a higher value representing a greater likelihood. This ranking is based on three inputs:

a profile or index of safety outcomes associated with a specific set of drug dosages 104, which is the output of the Safety Knowledge Tree 50,

a profile or index of efficacy outcomes associated with a specific set of drug dosages 106, which is the output of the Efficacy Knowledge Tree 74, and

a model of how the Regulatory Authorities weigh different safety/efficacy combinations 108. This last model represents an assessment of how the regulatory authorities make tradeoffs of safety and efficacy. For example, would regulatory authorities prefer a drug that is twice as effective as existing drugs on the market, but has some limited side effects vs. another drug that is only 10% better than existing drugs on the market, and has no side effects? The Medical Advantage Knowledge Tree 100 includes a transformation function 110, which converts the three inputs into a specific Medical Advantage index value. Such a transformation function would take the safety profile or index for each set of dosages, the efficacy profile or index for each set of dosages, and a model of how the regulatory authorities rank various combinations of safety results and efficacy results, and assign a medical advantage index (or “first index”) value, where the higher the value, the greater the probability of regulatory approval.

(b)Process Output Empirical Modeler (POEM) is used in developing quantitative models of relationships between the inputs and the outputs. This includes discretization to undertake population segmentation into subgroups and to identify significant patterns by subgroups. POEM is one example of a method that could be used to develop quantitative models of relationships between the inputs and the outputs. Other examples are linear regression, nearest neighbor, clustering, classification arid regression tree (CART), chi-square automatic interaction detector (CHAID), decision trees and neural network empirical modeling.

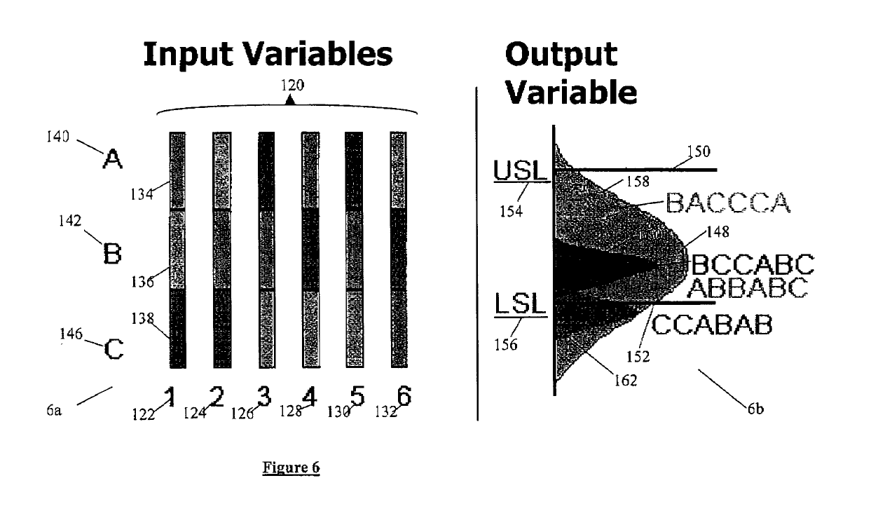

As an example of the POEM method described above, reference is now made to FIG. 6, which shows patterns of input values that are associated with their own distributions of output variable results FIG. 6 is a graphic representation of a feed forward optimization process, which is divided into two sections: a set of bars, section 6a; and, a bell-shaped curve, section 6b. The set of bars themselves, generally referenced 120, represent a set of input variables. In the section, six such variables are represented by bars 122-132. In this non-limiting example, each of the six bars 122-132 is in tarn divided into three sections.

For example, bar 122 is divided into an upper section 134, a middle section 136 and a lower section 138. These upper, middle, and lower sections (134, 136, and 138; respectively), are also assigned arbitrary letters in order to further facilitate graphic representation of some inputs to the process. The upper section 134 is assigned a letter-A, 140; the middle section 136 is assigned a letter-B, 142; and, the lower section 138 is assigned a letter-C, 146. The letters A, B, and C, are also used to designate the upper, middle, and lower sections, respectively; of bars 122-132. It should be noted that the choice of three letters and three sections is also completely arbitrary and has been made solely in order to simplify the description.

Although the letters A, B, and C are arbitrary, they represent specific subjective value ranges for each of the input variables represented by bars 122-132. The “A” or upper sections of each of the bars 122-132, represent input values greater than some pre-determined upper value for each input. The “C” or lower sections of each of the bars 122-132, represent input values less than some pre-determined lower value for each input. The B or middle sections of each of the bars 122-132, represent input values within the pre-determined upper and lower values for each input.

In FIG. 6b, a curved line 148 represents a bell-shaped curve. Curved line 148 is intersected by two straight lines: an upper (as depicted in section) line 150; and a lower (as depicted) line 152. Straight lines 150 and 152 are associated with three-lettered labels 122 and 124, respectively. Three-lettered label 154, which is designated USL., represents an upper specification limit; and three-lettered label 156, which is designated LSL., represents a lower specification limit.

Specification limits represent boundaries between favorable and unfavorable values for the output variable and can be set in a variety of fashions.

Referring now to FIG. 6b, there is seen inside of classically-shaped bell curve 148, a number of smaller, narrower-shaped curves 158,160 and 162, each of which represents the actual output responses associated with a vector of A or B or C values for the input variables corresponding to bars 122-132. For example, curve 158 is associated with the vector BACCCA for the input variables 122-132. Curves 158, 160 and 162 represent three of many possible curves each associated with a particular vector of the input values

(c)Optimization of dosages using optimization techniques such as APC techniques.

This involves analysis of patterns of input data for specific population subgroups and identification of dosage levels (and other controllable variables) that are associated with the achievement of targeted safe and efficacious medical outcomes for each population subgroup. In the analysis of blood serum lab results, POEM will identify particular patterns of blood test results (“signatures”) that play a key role in identifying preferred dosages for particular subgroups.

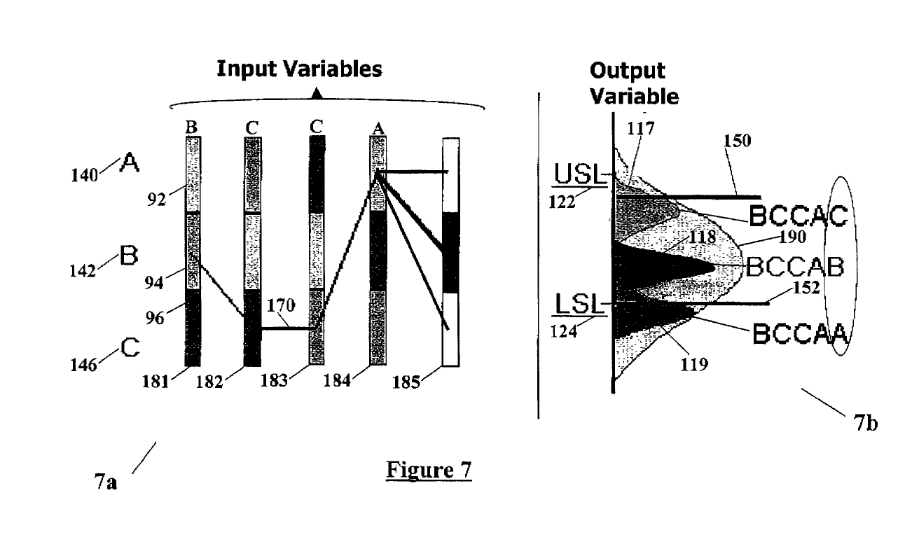

A preferred embodiment of the present invention is implemented by a computer that is programmed for the optimization of dosages for various segments of the population as illustrated in FIG. 7. A computer program first maps the complex process determining drug safety and efficacy This is done with the help of persons with expert knowledge about the process, and the mapping is characterized by breaking the fill process into several smaller interrelated processes or models, each with a manageable number of input and output variables. The map, called a Knowledge True, identifies input variables for which data are to be collected in order to predict the values of defined output variables measuring drug safety and efficacy. One of the input variables is the drug dosage given to patients. The list of variables for which data are to be collected may include variables not now collected in the prior art or collected with lesser frequency than recommended in the method. For example, it may be recommended that certain standard blood test results be monitored more frequently than is currently done and certain additional blood tests be undertaken which are now not undertaken.

Analysis of the data is undertaken using POEM, which looks at many population segments separately. POEM employs discretization, in which the values for continuous variables are grouped, where each discrete group is defined by a letter “A” 134, “B” 136, “C” 138, etc. or a label such as “high”, “medium”, “low”. The number of discrete groups shown in this example as three groups should not be seen as limiting in any way and may be more or less as the method demands.

Each population segment is defined by a vector 170 of input variable values that includes the dosage of the drug 185 and other input variables such as age 181, sex 182, body mass index 183, and blood test results 184, blood pressure (not shown), etc. The dosage 185 of the drug may have thee different dosage levels “A” 140, “B” 142, “C” 144, or “high”, “medium”, or “low”). An example of an input vector would be “male patients over the age of 60 having “medium” body mass index and a “high” cholesterol level, taking a “high” dosage of the drug.” Associated with this vector 170 is an average value and measure of variability for relevant output variables related to the drug's safety and efficacy.

As illustrated by vector 170 three different dosage levels 185 (A, B, C, or “high”, “medium”, or “low”) are given to patients with the same values for other input variables age 181, sex 182, body mass index 183, and blood test results 184. The combination of these other input values 181-184 and dosage A constitutes one population segment represented by curve BCCAA 119 in FIG. 7, the combination of these other input values and dosage B represents second population segment BCCAB 118 in FIG. 7b, and the combination of these input values and dosage C represents a third distinct population segment BCCAC 117 in FIG. 7b By the computer program determining how the safety and efficacy output values vary for these three population segments, the computer program identifies the preferred dosage for patients with the given other input variables (age, sex, body mass index, blood test results, etc.) Repeating this process for other combinations of the age, sex, body mass index, blood test results, etc. variables enables the computer program to generate a recommended dosage for each specific combination of these other input variables. The method also allows for extensive sensitivity analysis that show how a change in one specific variable affects outcomes.

Referring now to FIG. 7b, there is seen inside of “classically”-shaped bell curve 190, which is the distribution for all input combinations, three smaller, narrower-shaped curves, which represent the actual output responses associated with the input vectors represented by letter combinations BCCAA 119, BCCAB 118 and BCCAC 117.

Because at least some of the output values in the curve BCCAA 119 lie below the lower specification limit (LSL) 152, and at least some of the output values in the curve BCCAC 117 lie above the higher specification (USL) 150, representing unfavorable outcomes, the distribution BCCAB lies entirely within the range between the lower and upper specification limit, which therefore makes B the optimal dosage for this population segment.

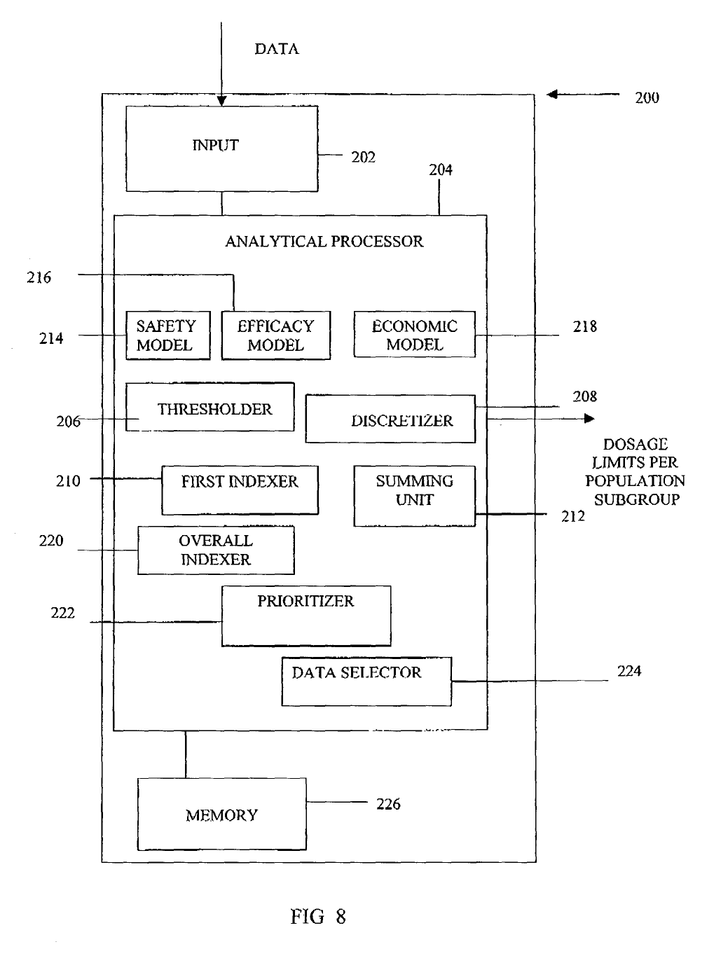

Reference is made to FIG. 8, which illustrates an apparatus for increasing a probability of a positive outcome of application over a population, of a pharmaceutically active product in accordance with the present invention, hereinafter referred to as apparatus 200. . No details of design, configuration or construction are provided, as apparatus 200 is susceptible to implementation in many different ways based upon existing technology available in the marketplace. One of ordinary skill in the art will find little trouble implementing the apparatus described.

Apparatus 200 comprises an input 202 for receiving data including patient data of the population, and dosage data, safety result data and efficacy result data of the application. Data may include patients undergoing clinical trials for a specific drug as well as data for similar patients not included in the clinical trials, as well as data for non-similar patients not included in the clinical trials. Data may include lab tests results, such as serum blood data Apparatus 200 also comprises an analytical processor 204 for analytically processing the data to form subgroupings within the population showing substantially similar results. The processor includes a safety model 214 that will analyze safety effects for population subgroupings, including the effects of different drug dosages, and an efficacy model 216 that will separately analyze efficacy effects for population subgroupings, including the effects of different drug dosages. The processor may then arrive at a safe and efficacious dosage recommendation of the pharmaceutically active product for at least one of the subgroupings, the analytical processor 204 being able to repeat the analytical processing to provide different sets of subgroupings of the population. The substantially similar results could be safety results, efficacy results or safety and efficacy results Analytical processor 204 is further operable to provide dosage recommendations subgrouping wise within the population. Analytical processor 204 includes a thresholder 206 to obtain a probability threshold to select the dosage recommendation. The threshold includes actuarial verifiability to provide an actuarially verifiable probability threshold. The analytical processor includes a discretization modeler 208 to analyze the population into discretized population subgroupings. Discretization modeler 208 is operable to represent the subgroupings as respective vectors within a discrete vector analytical model.

Apparatus 200 also comprises a first indexer 210 for indexing the subgroupings according to a combination of safety and efficacy levels. The first indexer works by taking safety results, efficacy results, and information about how regulatory authorities evaluate various safety and efficacy combinations and assigning a single index number to a given combination of safety and efficacy results. The higher the index value the greater the probability that the safety-efficacy combination would be approved by the regulatory authorities. Apparatus 200 also comprises a summing unit 212 for carrying out a summation of the index over respective sets, thereby to provide a means of comparing different sets to find an optimal set. Therefore, the apparatus could be used to maximize the probability that the drug will receive regulatory approval by choosing the set of dosages associated with the highest value of the first index.

Apparatus 200 also includes an economic model 218 for using economic data to calculate an economic value for each subgroup. The economic value would first depend on whether a subgroup will be taking the drug, and if so, would be based on an estimate of the population of the subgroup that would take the drug. Other economic factors such as market size, competition, marketing plans, pricing plans, and costs would be taken into account in order to generate an economic value, which may be projected revenues or other widely used financial measures and summing unit 212 is used for Summing the economic values over the sets. Therefore, the apparatus could be used to maximize the estimated economic value by choosing the set of dosages associated with the highest economic value.

Apparatus 200 also includes an overall indexer 220 for calculating a second index to express a combination of the first index and the economic value. The first index is a positively correlated with the probability that the, drug will be approved by regulatory authorities, and the economic value is a relevant measure of the revenues or other financial aspects of the drug. The overall index, otherwise known as second index, takes account of the tradeoff between different levels of the probability of regulatory approval and the drug's economic value to the pharmaceutical company, and the higher the value of the overall index, the greater the preference from the point of view of the pharmaceutical company. Each set of drug dosages for specific population subgroupings is there fore associated with a specific value for the overall index

Apparatus 200 also includes a prioritizer 222 for using the second index, the overall index, to prioritize sets of drug dosages having preferred combinations of safety, efficacy and economic value Therefore, apparatus 200 could be used to choose the set of dosages associated with the most highest ranked combination of probability of regulatory approval and economic value,

Apparatus 200 also includes a data selector 224 operable to use at least one technique selected from the group consisting of:

a knowledge tree, the knowledge tree including interconnection cells describing qualitative and quantitative relationships between inputs and outputs, and a decision making optimization technique, to select data to enable optimal forming of subgroupings.

Apparatus 200 further includes a memory unit 226 for registering relevant data about the drug for future use.

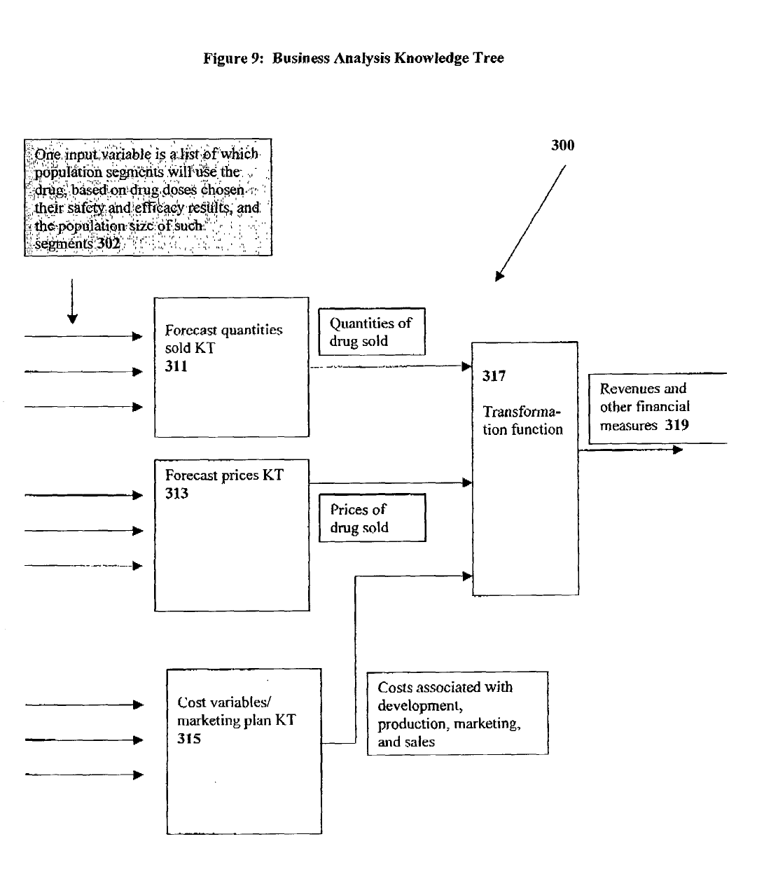

Reference is now made to FIG. 9, which is a simplified diagram showing the Business Analysis Knowledge Tree 300, which is a model that estimates revenues and other relevant financial measures of interest to the pharmaceutical company. It is assumed that the population is divided into segments and there is an estimate of the total population for each segment. A given set of drug dosages is considered, where, within that set, a drug dosage is chosen for each population segment. Following assessment of the safety and efficacy of each dosage, it will be decided which population segments would be included in the potential user population for the drug, for that set of drug dosages. The total of these population segments is one variable 302 that will enter into cell 311 whose output will be a forecast of the total quantities of the drug to be sold. Other input factors, possibly including incidence of the disease in the general population and the presence of competing drugs in the market, would also be inputs to cell 311. Cell 311 also takes account of the pharmaceutical company's planned marketing channels and planned marketing budgets, which would affect the extent of sales achieved. Cell 313 has as its output variable a forecast of the prices for the drug. Various input factors may include prices of competing drugs, role of sales to pharmacies and sales to drug formularies (in HMOs and hospitals). Another cell in this Knowledge Tree 315 may have as its output estimates of various costs associated with development, manufacturing, marketing and sales of the drug. Inputs would be various factors associated with each of these cost categories. The outputs of cells 311, 313, and 315 are inputs to cell 317, a transformation function whose outputs are various estimates of revenues, costs, and other financial measures relevant to the pharmaceutical company in its assessment of the economic results of the drug. This transformation function combines the projected sales quantities and projected drug prices to obtain revenue projections, and takes account of various investment and cost variables, in combination with revenue projections, to obtain other financial measures, which might include cash flow, Internal Rate of Return, Net Present Value, Payback Period, and other measures.

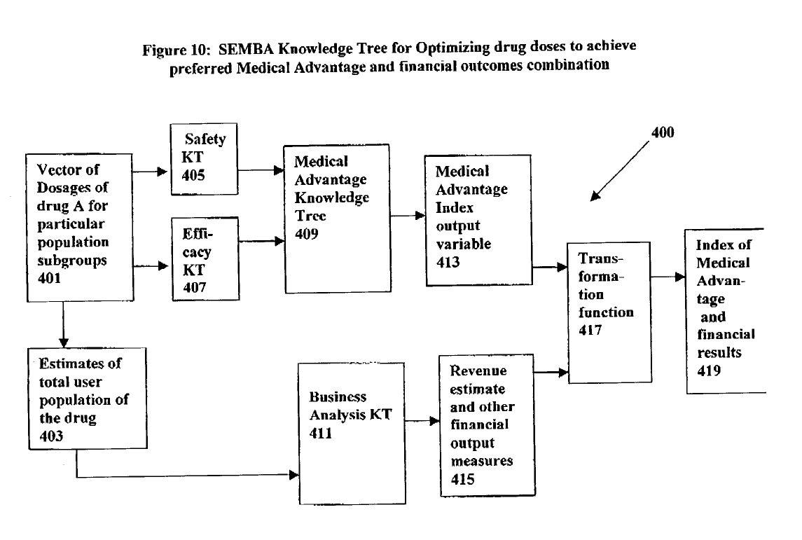

Reference is now made to FIG. 10, which is a simplified diagram of the SEMBA (Safety Efficacy Medical advantage Business Analysis) Knowledge Tree according to the teaching of the present invention 400, which integrates the Safety Knowledge Tree, the Efficacy Knowledge Tree, the Medical Advantage Knowledge Tree, and the Business Analysis Knowledge Tree. The output of the SEMBA Knowledge Tree is an index combining medical advantage (reflecting safety, efficacy, and the probability of regulatory approval) and the revenue and other financial measures that are the output of the Business Advantage Knowledge Tree. This index is also referred to as “the second index” figure 10 shows how a pharmaceutical company could assess a number of different sets of drug dosages for particular population segments, in order to choose the preferred set of dosages in light of the final second index output of the SEMBA Knowledge Tree. A specific set of dosages 401 is chosen for evaluation. These are inputs to the Safety Knowledge 1Tree 405 and the Efficacy Knowledge Tree 407. Associated with the specific vector of dosages is an estimate of the total user population of the drug 403, which is an input to the Business Advantage Knowledge Tree 411. The outputs of the Safety KT 405 and the Efficacy KT 407 are inputs into the Medical Advantage KT 409, whose output is the Medical Advantage Index 413, which reflects an assessment of the likelihood that the drug will receive regulatory approval. This output 413, and the revenue and financial measures output 415 of the Business Advantage KT 411, are inputs into the transformation function 417. One set of dosages might have a very high Medical Advantage index value (“the first index”), and might have a relatively low set of revenue of other financial projections. The transformation function would give a single index value to this combination A second set of dosages might involve a slightly lower Medical Advantage index value and a significantly higher level of revenues and other financial measures. The transformation function might give the second combination a higher value for the second index, reflecting the pharmaceutical company's assessment of how much it would be willing to trade reduced probability of regulatory authority approval for increased level of projected revenues and other financial measures. The output of this transformation function, the second index, is the final output of the tree 419, which is a combined measure that includes the likelihood of regulatory authority approval and the revenue and other financial measures. The idea is that by considering alternative sets of drug dosages, the pharmaceutical company can choose the set that is ranked most highly. The ranking does not only consider the likelihood of regulatory approval, nor does it only consider the expected revenue and financial results, but rather reflects a weighting of both factors.

The result of use of the above apparatus, typically embodied as a software system, is preferably a dosing regime characterized by a set of different recommended dosages for particular population segments, wherein the associated safety and efficacy outcomes are expected to be better than would be obtained with a more uniform dosing regime, of the kind typical with the prior art. By reducing the occurrence of adverse drug effects, the drug has a higher probability of receiving regulatory approval and, after it is introduced to the market, has a lower probability of causing adverse effects that would lead to its withdrawal or to a significant narrowing of its user population.

These techniques preferably enable population subgroups to be defined such that customized dosages—including possibly zero dosages [i.e. excluding the subgroup from the user population of the drug]—can be computed for each such subgroup to achieve improved efficacy results and reduced occurrence of potentially adverse drug effects.

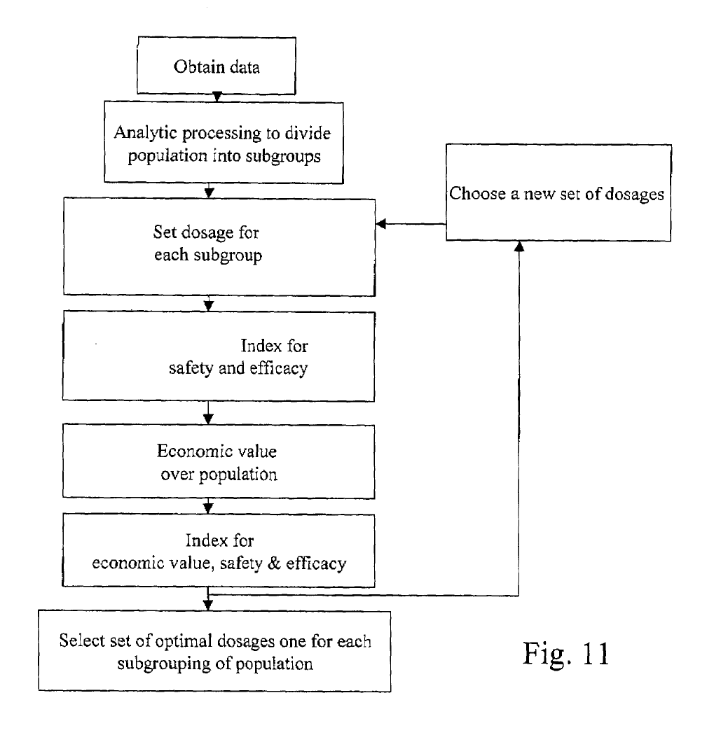

Reference is now made to FIG. 11, which is a simplified now chart showing a method of selecting a dosing regime for a population according to a preferred embodiment of the present invention. Effective, casy-to-use implementation of a method of increasing a probability of a positive outcome of application over a population, of a pharmaceutically active product, comprises stages as follows:

1) obtaining data including patient data of the population, and dosage data, efficacy result data and safety result data of the application, and

2) analytically processing the data to find subgroupings within the population that react similarly to the application, thereby to arrive at a safe and efficacious dosage recommendation of the pharmaceutically active product for at least one of the subgroupings. The safe dosage level recommendation is preferably arrived at, using the techniques discussed above, to maximize the probability of a positive outcome.

Different dosage regimes are tried over the population. For each one an economic value is calculated according to an economic model for each or the subgroups and then summed over the population. Different regimes are calculated, and then for each regime an overall index is calculated for a combination of the safety and efficacy index and for the economic value. The dosage regime giving the best overall index is then selected.

Alternately or additionally, the method may be applied when the drug has reached the market, so that a large population can be monitored. In the past, fill scale monitoring was restricted to early clinical trials since the post-marketing population was too large to collect data from and more particularly to process in a meaningful manner. The present embodiments not only allow large populations to be tracked meaningfully but also allow for the results to be available rapidly so that corrective action may be taken at an early stage. Use of the embodiments in the market preferably require a software program, that customizes the dosage for each patient based on the patient's characteristics (including serum data) and which population subgroup he/she belongs to. It may also require effective ways of incorporating the program into existing workflows.

By being able to detect significant patterns among finely defined segments of the population, the system's recommendations may result in doctors avoiding dosages that either might otherwise be dangerous in specific patients or might be non-efficacious.

The present embodiments show five principal differences over the prior art. First, the present method adds lab test data including blood serum data; second, the method adds historical databases of such lab test data and other data that is not currently included in prior art methods; third, the method adds analytic techniques that facilitates analysis of population segments; fourth, recommendations for use of the drug are not constrained to proposing a single dosage for all users (or perhaps a few variations of the standard dosage), but rather allow fine delineations of recommended dosages for various population subgroups, and fifth, the method enables pharmaceutical companies to systematically take account of both the probability of regulatory approval and revenue and other financial measures projections in choosing a preferred set of dosages to propose to regulatory authorities.

It is appreciated that certain features of the invention, which are, for clarity, described in the context of separate embodiments, may also be provided in combination in a single embodiment. Conversely, various features of the invention which arc, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombination of the various features described hereinabove as well as variations and modifications thereof which would occur to persons skilled in the art upon reading the foregoing description.

What is claimed is:

1. A method of increasing a probability of a positive outcome of application over a maximized population, of a pharmaceutically active product, the method comprising:
obtaining data including patient data of said population, and dosage data, efficacy data and safety result data of said application,
analytically processing said data to find subgroupings within said population that react similarly to said application, to relate dosage data to subgroupings within said population, thereby to arrive at a safe and efficacious dosage recommendation of said pharmaceutically active product for at least one of said subgroupings, said safe dosage level recommendation being arrived at to maximize said probability of a positive outcome, and
analytically processing said at least one subgrouping using associated financial data to find an economic value for said application to said subgrouping.

2. The method of claim 1, wherein said stage of analytically processing said data to find subgroupings comprises calculating a first index combining safety and efficacy levels for said dosage recommendation.

3. The method of claim 2, further comprising
repeating said stage of analytically processing said data to find a further set of at least one subgroupings, and
repeating said stage of analytically processing said at least one subgrouping, thereby to obtain a plurality of sets of at least one subgrouping each associated with a respective economic value, and each having a respective combined index of safety and efficacy.

4. The method of claim 3 further comprising, for each set of at least one subgrouping, calculating a second index, said second index expressing a combination of said respective economic value and said respective first index.

5. The method of claim 4 further comprising selecting one of said sets of at least one subgrouping based on said respective second index.

6. The method of claim 4, wherein said second index is calculated to provide a maximum for a best combination of said first index and said economic value, thereby to indicate a dosing regime subgroup set optimized for each of efficacy, safety and economic return.

7. The method of claim 1, wherein said analytically processing comprises finding a population subgrouping showing a substantially similar efficacy result following application of a predetermined dosage.

8. The method of claim 1, wherein said analytically processing comprises finding a population subgrouping, showing a substantially similar safety result following application of a predetermined dosage.

9. The method of claim 1, wherein said analytically processing comprises finding a population subgrouping showing substantially similar safety and efficacy results following application of a predetermined dosage.

10. The method of claim 8, wherein said safety result is at least one of a group comprising a liver function result, a QT result, and a renal performance result.

11. The method of claim 9, wherein said safely result is one of a group comprising a liver function result, a QT result, and a renal performance result.

12. The method of claim 2, wherein said first index is calculated to provide an optimal combination of safety and efficacy.

13. The method of claim 1, wherein said obtaining data comprises obtaining data of standard pharmaceutical product tests.

14. The method of claim 1, wherein said obtaining data comprises obtaining data of non-standard pharmaceutical product tests.

15. The method of claim 1, wherein said obtaining data comprises obtaining historical use data of said product.

16. The method of claim 1, wherein said obtaining data comprises obtaining historical data of other pharmaceutically active products similar to said product.

17. The method of claim 1, wherein said obtaining data is preceded by a stage of selecting patient data categories for providing a basis for defining respective population subgroupings.

18. The method of claim 1, further comprising providing dosage recommendations subgroupwise over said population.

19. The method of claim 1, wherein said obtaining data comprises obtaining blood serum level data of patients within said population.

20. The method of claim 1, comprising using a probability threshold to select said safe dosage recommendation.

21. The method of claim 1, wherein said probability threshold is an verifiable probability threshold.

22. The method of claim 1, wherein said obtaining data is preceded by a stage of selecting data categories to be obtained, and wherein said selecting comprises use of at least one technique selected from the group of:
a knowledge tree, said knowledge tree including interconnection cells qualitative and quantitative relationships between inputs and and
a decision making optimization technique.

23. The method of claim 1, wherein said analytically processing comprises using discrete vectorization modeling to analyze said population into said population subgroupings.

24. The method of claim 23, wherein said discrete vectorization modeling comprises representing said subgroupings as respective vectors within a discrete vector analytical model.

25. The method of claim 1, further comprising an updating stage of obtaining new data to an accumulated data mass, and using said updated accumulated data mass in repeat analytical processing, thereby to update said subgroupings.

26. The method of claim 18, further comprising an updating stage of obtaining new data to an accumulated data mass, and using said updated accumulated data mass in repeat analytical processing, thereby to update said subgroupwise dosage recommendations.

27. The method of claim 18, further comprising an updating stage of obtaining new data to an accumulated data mass, and using said updated accumulated data mass in repeat analytical processing, thereby to update said subgroupings and said associated subgroupwise dosage recommendations.

28. A method of increasing a probability of a positive outcome of application, over a population, of a pharmaceutically active product, the method comprising:
obtaining data including patient data of said population, and dosage data, safety result data, and efficacy result data of said application, and
analytically processing said data to relate said dosage data, said patient data, said safety result data and said efficacy data to said patient data, to form therefrom subgroupings within said population, each of said subgroupings being related by similarity in at least one of said types of data, thereby to arrive at an actuarially robust safe and efficacious dosage recommendation of said pharmaceutically active product for at least one of said subgroupings, said safe dosage level recommendation being arrived at to maximize said probability of a positive outcome, said method further comprising calculating for at least one of said subgroups a first index of a combination of respective safety and efficacy levels, said first index being usable to find subgroups optimized for said combination of safety and efficacy.

29. The method of claim 28, further comprising repeating said stage of analytically processing to obtain different subgroupings of said population, and using said first index to select between said subgroupings.

30. The method of claim 28, wherein said analytically processing comprises finding a population subgrouping showing a substantially similar efficacy result following application of a predetermined dosage.

31. The method of claim 28, wherein said analytically processing comprises finding a population subgrouping showing a substantially similar safety result following application of a predetermined dosage.

32. The method of claim 28, wherein said obtaining data is preceded by a stage of selecting data categories to be obtained, said selecting comprising use of at least one technique selected from the group consisting of:
a knowledge tree, said knowledge tree including interconnection cells describing qualitative and quantitative relationships between inputs and outputs, and
a decision making optimization technique.

33. The method of claim 28, wherein said analytically processing comprises using discrete vectorization modeling to analyze said population into said population subgroupings.

34. A method of distinguishing between different ways of dividing a population into dosage application subgroups for treatment with an active pharmaceutical product, the method comprising:
providing a plurality of sets of subgroupings of said population,
for said population obtaining economic data,
for each subgrouping generating an economic value of providing said treatment to said subgroup,
indexing each set according to economic values of respective subsets, and
selecting one of said sets based on at least said indexing.

35. Apparatus for increasing a probability of a positive outcome of application over a population, of a pharmaceutically active product, the apparatus comprising:
an input for receiving data including patient data of said population, and dosage data, safety result data and efficacy result data of said application,
an analytical processor for analytically processing said data to form subgroupings within said population showing substantially similar results, thereby to arrive at a safe and efficacious dosage recommendation of said pharmaceutically active product for at least one of said subgroupings, said safe dosage level recommendation being arrived at to maximize said probability of a positive outcome, said analytical processor being able to repeat said analytical processing to provide different sets of subgroupings of said population,
a first indexer for indexing said subgroupings according to a combination of safety and efficacy levels, and
an index summing unit for carrying out a summation of said index over respective sets, thereby to provide a means of comparing different sets to find an optimal set.

36. The apparatus of claim 35, further comprising:
an economic model for using economic data to calculate an economic value for each subgroup, and
an economic summing unit for summing said economic values over said sets.

37. The apparatus of claim 36, further comprising an overall indexer for calculating a second index to express a combination of said first index and said economic value.

38. The apparatus of claim 37, further comprising a prioritizer for using said second index to prioritize sets having best combinations of safety, efficacy and economic value.

39. The apparatus of claim 35, wherein said substantially similar results are safety results.

40. The apparatus of claim 35, wherein said substantially similar results are efficacy results.

41. The apparatus of claim 35, wherein said substantially similar results comprise a combination of safety and efficacy results.

42. The apparatus of claim 35, wherein said analytical processor is further operable to provide dosage recommendations subgroupingwise within said population.

43. The apparatus of claim 35, wherein said analytical processor comprises a thresholder to obtain a probability threshold to select said dosage recommendation.

44. The apparatus of claim 43, wherein said threshold comprises actuarial verifiability to provide an actuarially verifiable probability threshold.

45. The apparatus of claim 35, further comprising a data selector operable to use at least one technique selected from the group consisting of:
a knowledge tree, said knowledge tree including interconnection cells describing qualitative and quantitative relationships between inputs and outputs, and
a decision making optimization technique, to select data to enable optimal forming of subgroupings.

46. The apparatus of claim 35, wherein said analytical processor comprises a discretization modeler to analyze said population into discretized population subgroupings.

47. The apparatus of claim 46, wherein said discretization modeler is operable to represent said subgroupings as respective vectors within a discrete vector analytical model.

48. The apparatus of claim 35, further comprising a memory unit for registering ownership information relating to said active pharmaceutical product, thereby to facilitate ownership transfer in case of occurrence of said negative outcome.

49. Combination population subgroup identifier and pharmaceutical application dosage calculator comprising:
a first input for receiving patient specific categorization data of patients in a population, said data being selected by suitability for define population subgroups with respect to said application,
a second input for receiving applied dosage data patientwise,
a third input for receiving efficacy result data of said application patientwise,
a fourth input for receiving safety result data of said application patientwise,
a processor for processing data of said inputs to define subgroups of said population showing similar result data,
a dosage determiner for applying at least one of a safety threshold rule and an efficacy threshold rule to at least one of said subgroups to determine a safe or efficacious dosage level for said at least one subgroup, and
and indexer for applying to said at least one subgrouping an index expressing a combination of a safety level and an efficacy level of said subgrouping.

50. The combination of claim 49, further comprising a fifth input for receiving commercial data relating to said application, and further comprising an economic modeler for using said commercial data to apply an economic value to said subgroup.

51. The combination of claim 50, further comprising a combined index calculator for calculating a combined index of said safety and efficacy index and said economic value.

52. The combination of claim 51, further comprising a summator for summing said combined index over subgroupings of said population thereby to provide an overall measure of economic value, safety and efficacy to any given treatment subgroup arrangement of said population such that different treatment subgroup arrangements are rendered comparable.

53. The combination of claim 49, wherein at least one of said inputs is associated with a data selector for selecting data categories for input.

54. The combination of claim 53, wherein said data selector comprises a qualitative model constructor for allowing a user to construct a qualitative model of relevant data for input followed by a quantitative modeler for using a database to quantify links of said qualitative model, said data selector using said quantitative model to select data for input.
